(19) United States
(12) Patent Application Publication
(10) Pub. No.: US 2024/0267849 A1
(43) Pub. Date: Aug. 8, 2024

(54) SYSTEMS AND METHODS FOR OPERATING IN A LOW-POWER STATE

(71) Applicant: ZTE Corporation, Shenzhen (CN)

(72) Inventors: Ting LU, Shenzhen (CN); Bo DAI, Shenzhen (CN); Xiubin SHA, Shenzhen (CN); Li NIU, Shenzhen (CN)

(73) Assignee: ZTE Corporation, Shenzhen (CN)

(21) Appl. No.: 18/640,892

(22) Filed: Apr. 19, 2024

Related U.S. Application Data
(63) Continuation of application No. PCT/CN2021/131074, filed on Nov. 17, 2021.

(51) Int. Cl. H04W 52/02; H04W 76/19; H04W 76/20

(52) U.S. Cl. CPC H04W 52/0235; H04W 52/0274; H04W 76/19; H04W 76/20

(57) ABSTRACT

Presented are systems and methods for operating in a low-power state. A wireless communication device may enter a first low-power operating state to monitor for a defined signal. The wireless communication device may monitor for the defined signal, while in the first low-power operating state.

### CROSS-REFERENCE TO RELATED APPLICATION

This application claims the benefit of priority under 35 U.S.C. § 120 as a continuation of PCT Patent Application No. PCT/CN2021/131074, filed on Nov. 17, 2021, the disclosure of which is incorporated herein by reference in its entirety.

### TECHNICAL FIELD

The disclosure relates generally to wireless communications, including but not limited to systems and methods for operating in a low-power state.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A wireless communication device may enter a first low-power operating state to monitor for a defined signal. The wireless communication device may monitor for the defined signal, while in the first low-power operating state.

In some embodiments, monitoring for the defined signal may comprise monitoring for the defined signal continuously or intermittently over a length of time. In certain embodiments, the defined signal can include a wake-up signal (WUS) or a signal for triggering state transition. In some embodiments, the wireless communication device can monitor for the defined signal, while the wireless communication device is in the first low-power operating state or in a second low-power operating state. In certain embodiments, the second low-power operating state may comprise: a radio resource control (RRC) idle state, a RRC inactive state, a RRC connected state, or a state that incorporates at least one period of being in the first low-power state. In some embodiments, entering the first low-power operating state may comprise transitioning between a low-power off state and the first low-power operating state, according to a defined configuration, or a configuration from a wireless communication node. The transitioning can be according to at least one of: a defined duty cycle between the low-power off state and the first low-power state, a transition between the low-power off state and the first low-power state after a defined time period or according to a defined periodicity, a transition between the low-power off state and the first low-power state according to a defined length of time period when no signal is detected, a transition between the low-power off state and the first low-power state according to a defined number of detections in which no signal is detected, a transition between the low-power off state and the first low-power state if energy detected from the defined signal meets a condition with respect to a pre-defined or configured first threshold, or a transition between the low-power off state and the first low-power state if an amount of change in energy detected from the defined signal meets a condition with respect to a pre-defined or configured second threshold.

The wireless communication device may transition between a first state and a second state, according to at least one of: an event, an indication in the defined signal, another defined signal, a specific type of defined signal, a defined length of time period when no signal is detected, a defined number of detections in which no signal is detected, energy detected from the defined signal, an amount of change in energy detected from the defined signal, energy detected from the defined signal exceeds a pre-defined or configured first threshold, a result of comparing an amount of change in the energy detected from the defined signal with a pre-defined or configured second threshold, channel quality measured after a condition between energy detected from the defined signal and the pre-defined or configured first threshold is fulfilled, channel quality measured after a condition between an amount of change in energy detected from the defined signal and the pre-defined or configured second threshold is fulfilled, channel quality measured after a condition between energy detected from the defined signal and the pre-defined or configured first threshold is fulfilled, meets another condition with respect to a pre-defined or configured third threshold, or change of channel quality measured after a condition between an amount of change in energy detected from the defined signal and the pre-defined or configured second threshold is fulfilled, meets another condition with respect to a pre-defined or configured fourth threshold. In certain embodiments, the first state and the second state each may comprise: the first low-power operating state, a low-power off state, a combination state that incorporates at least one period of being in the first low-power state, or a legacy state comprising a radio resource control (RRC) idle state, a RRC inactive state, or a RRC connected state.

In certain embodiments, the wireless communication device may transition from the first low-power operating state to the legacy state, in response to receiving the defined signal that includes an indication that a network may have a message for the wireless communication device, or that the network may intend to wake up the wireless communication device. In some embodiments, the wireless communication device may transition from the first low-power operating state to the low-power off state, if the defined signal is not detected after a first defined duration. In certain embodiments, the wireless communication device may transition from the low-power off state to the first low-power operating state, after a second defined duration. In some embodiments, the wireless communication device may transition from the first low-power operating state to the legacy state, if: the defined signal, or the defined signal that includes an indication that a network may have a message for the wireless communication device, is not detected after a first defined duration, or the wireless communication device detects a cell change. In certain embodiments, the wireless communication device may transition from the first low-power operating state to the second state, in response to the defined signal indicating to transition specifically to the second state.

In some embodiments, the wireless communication device may send a message to a wireless communication node to stop transmission of defined signals, prior to transitioning to a low-power off state. In certain embodiments, the wireless communication device may transition from the first low-power operating state to the low-power off state, after sending the message. In some embodiments, the defined signal can be specifically configured for the wireless communication device or for a device group that includes the wireless communication device. In certain embodiments, the defined signal may be scheduled on at least one resource specifically configured for the wireless communication device, or for the device group. In some embodiments, the wireless communication device may detect at least one defined signal each corresponding to a respective cell and indicative of at least one of: an existence of the respective cell or a channel quality of the respective cell. In some embodiments, the wireless communication device may detect at least one defined signal each corresponding to a respective cell. The wireless communication device may perform clock synchronization using the at least one defined signal. In some embodiments, the defined signal may include an indication to activate or deactivate the monitoring of subsequent defined signals. In certain embodiments, the defined signal may include an indication to indicate arrival of a paging message to one or more devices that moved from another cell to the respective cell.

In certain embodiments, the wireless communication device may determine whether the wireless communication device is within a signal coverage region for receiving the defined signal. In some embodiments, the wireless communication device may enter or maintain the first low-power operating state in response to being within the signal coverage region. In some embodiments, the wireless communication device may send at least one of: a request for extending time domain resources for the defined signal or increasing a transmission energy for the defined signal, an indication of a time duration for the wireless communication device to transition from the first low-power operation state or a state incorporating the first low-power operation state, to a radio resource control (RRC) idle state or a RRC inactive state, or a capability of the wireless communication device to support the defined signal. In certain embodiments, the wireless communication device may receive at least one of: a configuration for the defined signal, an indication for triggering a transition between states, or an indication for indicating to the wireless communication device to enter the first low-power operating state.

In some embodiments, the configuration or the indication is received via at least one of: a dedicated signaling, a broadcast signaling, a user plane packet, or a downlink signaling during at least one of: radio resource control (RRC) establishment procedure, RRC resume procedure, RRC reconfiguration procedure, RRC reestablishment procedure, RRC release procedure, early data transmission procedure, or small data transmission procedure. In certain embodiments, the configuration includes at least one of: at least one manner for transitioning between states, a manner for monitoring the defined signal, a criteria for determining a signal coverage region or range for the defined signal, a criteria or threshold for determining infeasibility of performing monitoring for the defined signal, or for triggering a transition to a radio resource control (RRC) idle state or a RRC inactive state, a design or format of the defined signal, or a design or format for at least one defined signal each corresponding to a respective cell. In some embodiments, the wireless communication device may determine whether the configuration is for a cell in which the wireless communication device currently resides. In certain embodiments, the wireless communication device may use the configuration if the configuration is for the cell in which the wireless communication device currently resides. The wireless communication device may terminate the monitoring of the defined signal if the configuration is not for the cell in which the wireless communication device currently resides. The wireless communication device may monitor the defined signal if the configuration is for the cell in which the wireless communication device currently resides.

At least one aspect is directed to a system, method, apparatus, or a computer-readable medium (e.g., a non-transitory computer readable medium). A wireless communication node (e.g., a ground terminal, a base station, a gNB, an eNB, or a serving node) may detect no signal or indication from a wireless communication device, or no signal or indication from any wireless communication device. The wireless communication node may indicate a status of the wireless communication device to a core network. The wireless communication node may send paging in a fallback mode to the wireless communication device. The fallback mode may comprise sending the paging in a defined way, sending the paging using defined resources, sending the paging based on a configuration or indication from the core network, or sending the paging in all cells in a registration area of the wireless communication device.

At least one aspect is directed to a system, method, apparatus, or a computer-readable medium (e.g., a non-transitory computer readable medium). A wireless communication node may provide a configuration for transmitting a defined signal or an indication. The wireless communication node may transmit the defined signal.

In certain embodiments, the configuration can include at least one of: at least one manner for transitioning between states, a manner for monitoring the defined signal, a criteria for determining a signal coverage region or range for the defined signal, a criteria or threshold for determining infeasibility of performing monitoring for the defined signal, or for triggering a transition to a radio resource control (RRC) idle state or a RRC inactive state, a design or format of the defined signal, or a design or format for at least one defined signal each corresponding to a respective cell. In some embodiments, the indication can include at least one of: an indication for triggering a transition between states in a wireless communication device, or an indication for indicating to the wireless communication device to enter a first low-power operating state.

The systems and methods discussed herein can include novel approach for defining and/or configuring a novel low-power operating state and/or sub-states, such as LP-WUS_IDLE, LP-WUS_INACTIVE, LP-WUS-ON and/or LP-WUS-OFF. The novel approach may describe one or more transition operations between the novel low-power operating states and/or other operating states (e.g., legacy states). The systems and methods described herein can include novel approach for configuring and/or determining a novel defined signal for a wireless communication device (e.g., UE) and/or for a device group (e.g., UE group-specific defined signal). The defined signal (e.g., LP-WUS signal) can be used for detecting cells and/or determining a channel quality of the cells. In certain embodiments, the defined signal can be a cell-specific defined signal. Furthermore, the systems and methods described herein can include a configuration for the defined signal, and/or a request for the defined signal. In certain embodiments, the systems and methods can include criteria for determining whether a wireless communication device is located within an area/range of the defined signal.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIGS. 3-4 illustrate example low-power configurations of a wireless communication device, in accordance with some embodiments of the present disclosure;

FIGS. 5A-5B illustrate example configurations for generating on-off keying (OOK) symbols, in accordance with some embodiments of the present disclosure;

FIG. 6 illustrates example performance values for ultra low-power receivers, in accordance with some embodiments of the present disclosure;

FIG. 7 illustrates example transitions between low-power operating states, in accordance with some embodiments of the present disclosure; and

FIGS. 8-9 illustrate flow diagrams of example methods for operating in a low-power state, in accordance with some embodiments of the present disclosure.

### DETAILED DESCRIPTION

### 1. Mobile Communication Technology and Environment

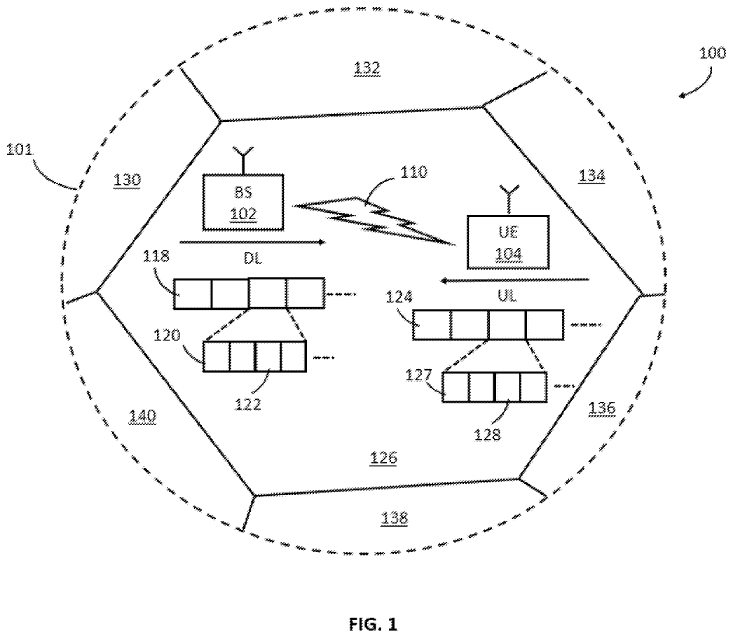

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

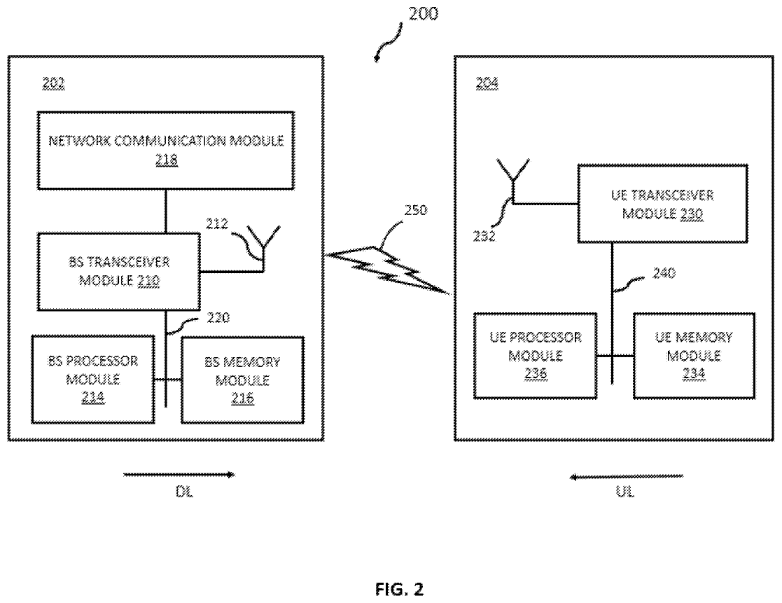

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Operating in a Low-Power State

Internet of things (IoT) applications are becoming increasingly ubiquitous across a plurality of environments (e.g., smart factories, smart warehouses, smart homes, wearable health technology, smart cars, smart grids, smart cities, and/or other applications/environments), thereby introducing certain performance requirements for IoT systems and/or devices (e.g., devices/systems with a longer battery life and/or lower latency). For example, in scenarios with fire-detection and/or fire-extinguishment applications, actuators can close certain (IoT) devices (such as fire shutters) and/or enable (e.g., turn on) other devices (e.g., fire sprinklers) upon detection of a fire. In another example, one or more devices (e.g., IoT wireless communication devices) of a smart home (or other smart environments) can respond (e.g., respond to a request) in less time (e.g., lower latency), according to certain instructions (e.g., instructions configured by an owner of the smart home).

In certain embodiments, one or more sensors and/or devices (e.g., IoT sensors and/or wireless communication devices) can be disconnected from a power grid (e.g., off the grid). As such, said sensors and/or devices may use batteries, solar power, wireless transfer of energy, and/or other sources to maintain and/or obtain power. However, in certain scenarios/applications, the number, amount and/or quantity of sensors/devices can be large, such that charging and/or replacing a battery of each sensor/device can become difficult and/or expensive. Therefore, said sensors and/or devices (e.g., wireless communication devices) can be configured and/or designed to consume less power (e.g., low-power devices) and/or have a longer battery life (e.g., to avoid frequent charging and/or replacement of batteries).

Some devices (e.g., legacy devices, such as IoT devices, wireless communication devices, and/or other devices) in certain systems (e.g., international mobile telecommunication (IMT) systems) can use one or more approaches (e.g., discontinuous reception (DRX)-based approaches, power save mode (PSM)-based approaches, and/or other approaches) to reduce and/or decrease the power consumption of the device(s) (e.g., with sparse uplink (UL) and/or downlink (DL) services). In order to achieve a lower/reduced consumption of power (e.g., to meet certain low-power consumption requirements), the device(s) can use larger cycles (e.g., extended discontinuous reception (eDRX) cycle). However, larger cycles may result in higher latency values (e.g., latency of transmit (Tx) and/or receive (Rx) operations), which can be unsuitable for applications with low latency requirements. The systems and methods presented herein include a novel approach for enhancing and/or improving the power-saving capabilities of a wireless communication device (e.g., a UE, a terminal, an IoT device, or a served node), to decrease an amount of power being consumed by the wireless communication device without increasing latency values associated with the device.

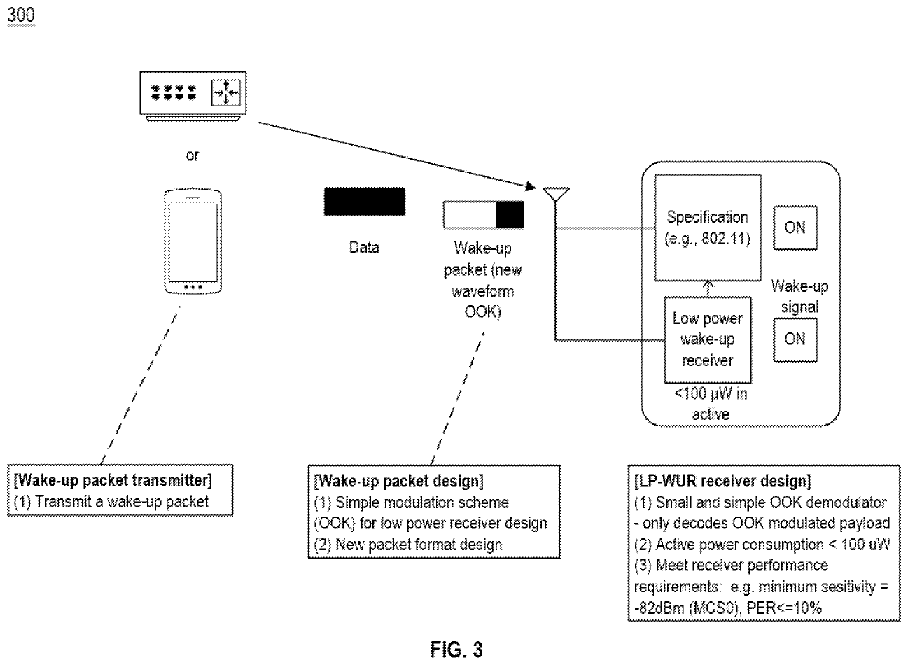

Certain approaches can reduce and/or decrease the power consumption of the wireless communication device, and/or extend a battery life of the wireless communication device (e.g., IoT wireless communication devices). As seen in FIG. 3, and in some embodiments, an additional low-power radio receiver can be incorporated into the wireless communication device (e.g., to reduce the power consumption of the wireless communication device). The additional low-power radio receiver can listen for a call from a wireless communication node (e.g., a ground terminal, a base station, a gNB, an eNB, or a serving node). Responsive to receiving a call, the wireless communication device may enable (e.g., turn on) a Wi-Fi radio capability, and/or exchange data (or other transmissions/communications) with the wireless communication node. In some embodiments, certain operating states and/or modes (e.g., an always-on Low-Power Wake-Up Radio (LP-WUR)) may cause the wireless communication device to consume 0.105 mW (and/or other values). Applying and/or using a 2% (or other percentages) duty cycle (in conjunction with the operating states/modes) may cause a further decrease in a consumption of radio power by the wireless communication device (to 0.007 mW, for example).

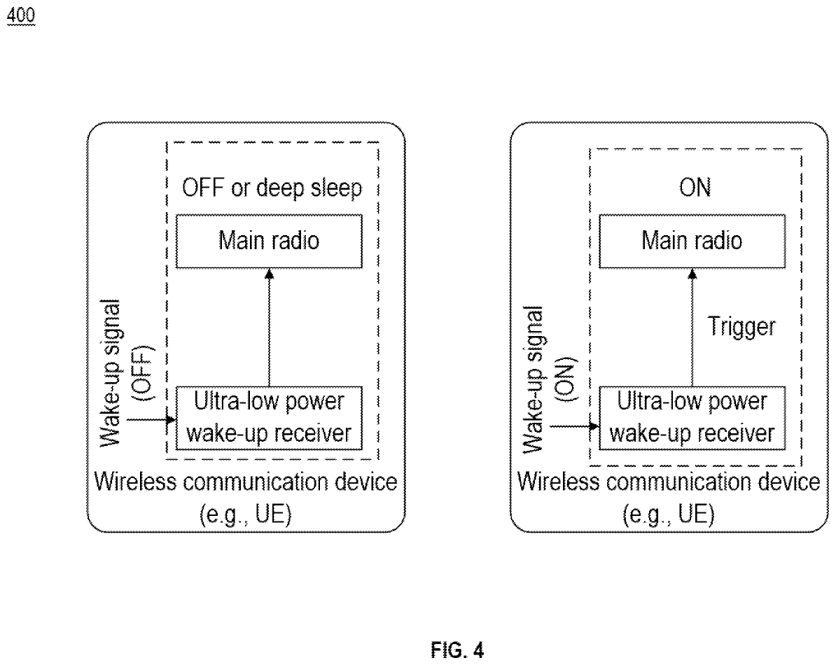

In certain low-power applications, a wireless communication device can use a defined signal (e.g., a wake-up signal (WUS)) and/or receiver (e.g., wake-up receiver (WUR)). Referring now to FIG. 4, and in some embodiments, the wireless communication device (e.g., a UE) can use a separate receiver (e.g., ultra-low power WUR) for monitoring and/or detecting a defined signal (e.g., a WUS and/or other signals) using ultra-low power consumption. The defined signal may be used for triggering a main radio of the wireless communication device. The main radio of the wireless communication device (as seen in FIG. 4) can perform Tx and/or Rx operations. Furthermore, the main radio can be turned off and/or enter a deep-sleep mode, unless triggered by a receiver (e.g., WUR) and/or a defined signal (e.g., WUS).

According to certain approaches described herein, a power consumption of the wireless communication device (e.g., a wireless communication device in an operating state, such as a radio resource control (RRC) idle state and/or RRC inactive state) may be reduced while achieving a low paging latency. In certain embodiments, such low-power receivers (e.g., WUR) may not be digital receivers, and/or can avoid direct digitization of signals (e.g., radio frequency (RF) signals). Furthermore, the low-power receivers may include or correspond to a passive envelope detector for detecting a waveform (e.g., an on-off keying (OOK) waveform), which can require a simple energy accumulation.

However, detecting and/or monitoring a defined signal (e.g., an ultra-low power wake up signal), as described above, may have one or more disadvantages. For instance, certain components, such as a power amplifier (PA), may be removed from the wireless communication device, thereby resulting in a loss of coverage of the wireless communication device. Furthermore, the wireless communication device may have certain requirements on restricted mobility, and as such, the wireless communication device may be unable to perform and/or obtain measurements. Moreover, coexisting transmissions of other wireless communication devices (e.g., in a same wireless communication network) can increase the power consumption of the network, thereby causing an impact on transmission and/or system performance.

In certain embodiments, the power consumed (e.g., by the wireless communication device) as a result of monitoring a defined signal (e.g., a wake-up signal (WUS)) can be associated with a design of the defined signal and/or hardware modules of an auxiliary receiver (e.g., used by the wireless communication device for detecting and/or processing the defined signal).

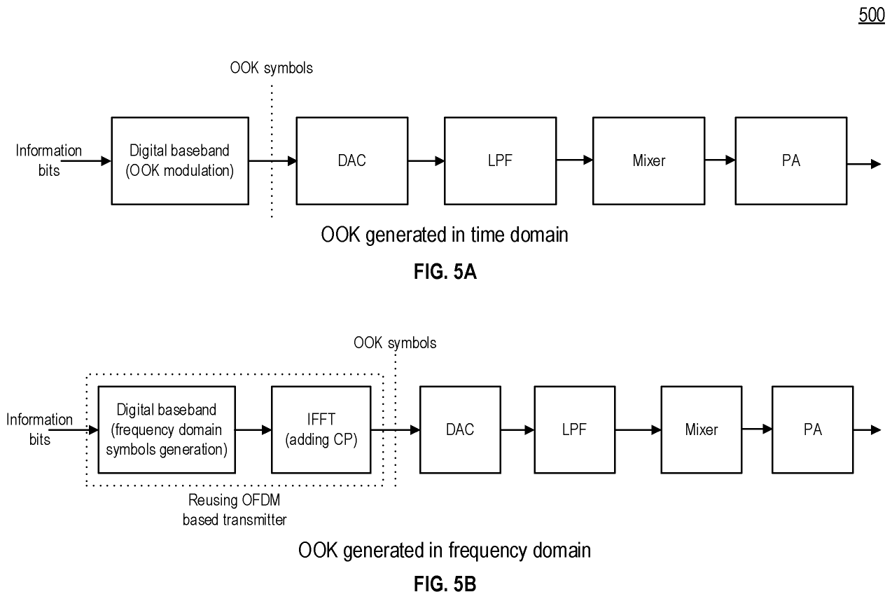

For certain receivers, such as an almost-zero power (AZP) wake-up receiver, an envelope detector can be used to reduce the power consumption by at least 100×-1000× (e.g., from tens of mW to 0.01-0.1 mW). Using an OOK waveform as the defined signal, for instance, may result in a reduction of power consumption, enabling a usage of a simplified energy accumulation and comparator and/or other simplified designs for the receiver. As a result, the power consumption of the wireless communication device can be further reduced to a lower level, enabling certain operating modes of the wireless communication device (e.g., an ultra-low power UE/device standby operating mode). In certain embodiments, envelope detection may decrease and/or degrade a sensitivity (e.g., down to 60 dB-80 dB). As shown in FIG. 5A, and in some embodiments, an AZP wake-up transmitter can generate OOK symbols in the time domain. In some embodiments, as seen in FIG. 5B, an OFDM-based transmitter can be reused (e.g., generating OOK symbols in the frequency domain by configuring proper coefficients for each orthogonal frequency-division multiplexing (OFDM) carrier, and/or performing an inverse fast Fourier transform (IFFT) to obtain the OOK symbols). As such, an AZP defined signal (e.g., wake up signal) can be generated without changes to a hardware design of the receiver (e.g., by using an existing OFDM generator of a gNB transmitter).

In certain embodiments, an out-of-band and/or an in-band operation can be useful for an ultra-low power wake-up receiver (WUR). A dedicated carrier (e.g., for purposes of a defined signal) may decrease an efficiency of resources and/or cause an inflexible deployment (e.g., for operator). To support certain scenarios (e.g., scenarios with a wake-up signal and/or a legacy system deployed in one carrier), a defined signal (e.g., wake-up signal) and a legacy signal/channel may coexist in a same system.

The systems and methods described herein may discuss a usage of a novel defined signal (e.g., a low-power wake-up signal (LP-WUS)) by a wireless communication device. Furthermore, said systems and methods may consider (e.g., take into consideration) one or more trade-offs between saving/reducing power consumption (e.g., of the wireless communication device) and/or improving service performance (e.g., alleviating issues of restricted mobility and reduced coverage).

### A. Embodiment 1: Operating State Transition

In some embodiments, a wireless communication device may use the novel defined signal (e.g., LP-WUS signal) according to a particular operating state (and/or operating sub-state).

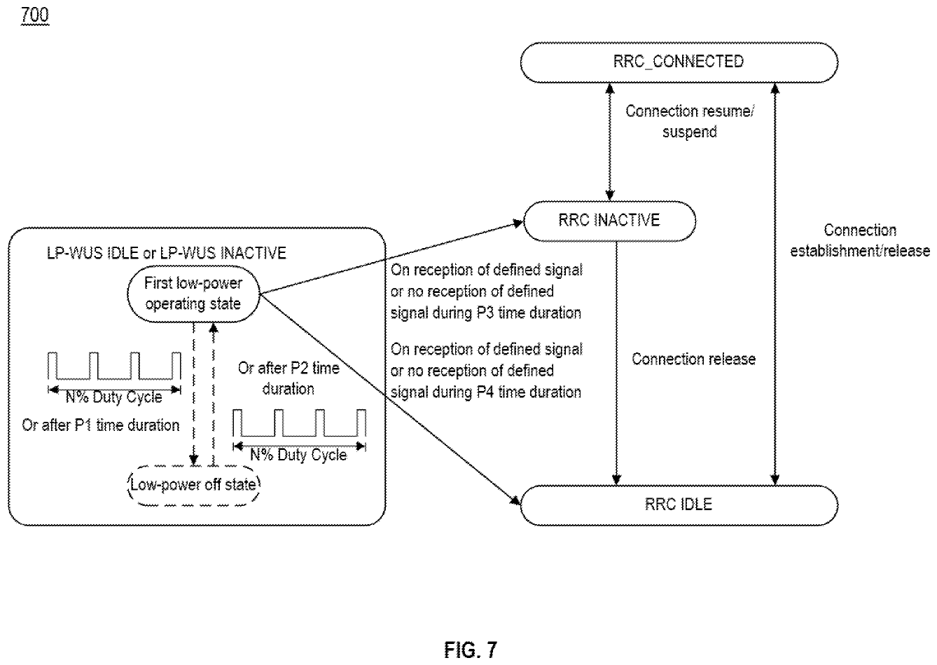

As discussed in FIG. 7, a wireless communication device in a second low-power operating state (e.g., a RRC idle state and/or RRC inactive state) can monitor and/or detect the defined signal (e.g., LP-WUS and/or an energy-saving wake-up signal) continuously.

In certain embodiments, the wireless communication device in a second low-power operating state can monitor and/or detect the defined signal (e.g., LP-WUS and/or an energy-saving wake-up signal) intermittently over a length of time (e.g., according to a duty cycle). The wireless communication device can remain, enter and/or transition into a first low-power operating state (e.g., a sub-state, such as LP-WUS-ON). In some embodiments, the wireless communication device may remain, enter and/or transition into a low-power off state (e.g., another sub-state, such as LP-WUS-OFF). In the low-power off state, the wireless communication device can stop, disable and/or cancel monitoring of the DL, including the monitoring for the defined signal (e.g., LP-WUS). In the first low-power operating state, the wireless communication device may monitor for the defined signal.

Regarding restricted mobility considerations, a potential processing approach may allow certain wireless communication devices to skip and/or omit the measurements. However, certain devices may perform occasional measurements. For such cases, we can provide an opportunity for the wireless communication device(s) to perform necessary measurements.

Based on the above considerations, the following operating state transitions (e.g., for a wireless communication device monitoring a defined signal) can be considered:
The wireless communication device can remain in a first low-power operating state or in a second low-power operating state (e.g., a state or a sub-state) to receive the defined signal. As such, the wireless communication device may monitor for the defined signal while the wireless communication device is in the first low-power operating state or in a second low-power operating state. The second low-power operating state may include a legacy state, such as a RRC idle state (RRC_IDLE) and/or RRC inactive state (RRC_INACTIVE), and/or a RRC connected state (RRC_CONNECTED). In certain embodiments, the second low-power operating state can be a new state (e.g., LP-WUS_IDLE and/or LP-WUS_INACTIVE state). The first low-power operating state can include a LP-WUS-ON sub-state. In certain embodiments, the new state (e.g., LP-WUS_IDLE or LP-WUS_INACTIVE state) can be a simple state. In some embodiments, the new state (e.g., LP-WUS_IDLE or LP-WUS_INACTIVE state) can be a combination (state) of one or more sub-states (e.g., LP-WUS-ON and LP-WUS-OFF sub-states), such as a state that incorporates at least one period of being in the first low-power state.
In certain embodiments, a transition between operating states (e.g., transitioning between a low-power off state and the first low-power operating state) can be according to a defined (e.g., pre-defined and/or default) configuration, and/or a configuration from a wireless communication node.
   In some embodiments, the transitioning can be according to a defined duty cycle (e.g., N %) between the low-power off state and the first low-power state. As such, the wireless communication device can be in one operating state N % of the time, and in another operating state (1−N) % of the time (e.g., see FIG. 7).
   In some embodiments, the transitioning (e.g., a transition between the low-power off state and the first low-power state) can be according to (e.g., after) a defined time period and/or a defined periodicity. For instance, the wireless communication device can transition to a first low-power operating state (e.g., LP-WUS-ON sub-state) a time period (e.g., D1 time period) after entering into an idle state and/or an inactive state (or other operating states). In certain embodiments, a wireless communication device can transition into the first low-power operating state (e.g., LP-WUS-ON sub-state) at an absolute time point after entering an idle state and/or inactive state (or other operating states). In certain embodiments, the wireless communication device can transition into the first low-power operating state (e.g., LP-WUS-ON sub-state) from an idle state and/or an inactive state (or other operating states) according to a defined periodicity.
In certain embodiments, the wireless communication device may transition between a first operating state and a second operating state according to (e.g., in response to, triggered by, upon meeting a condition comprising, after, based on a result of, etc.) an event. For instance, the operating state transition between LP-WUS-ON (e.g., the first low-power operating state) and LP-WUS-OFF (e.g., the low-power off state, and/or other operating states) can be triggered by one or more events. In one example, the operating state transition between LP-WUS-ON/LP-WUS-OFF (or a new state, such as LP-WUS_IDLE or LP-WUS_INACTIVE (e.g., a simple state) or a combination of LP-WUS-ON and LP-WUS-OFF sub-states) and one or more legacy states can be triggered by one or more events.
   At the beginning, the wireless communication device can remain in a first low-power operating state (e.g., LP-WUS-ON sub-state).
   At the beginning, the wireless communication device can remain in a normal/legacy state (e.g., RRC idle state, RRC inactive state, and/or RRC connected state) to determine and/or verify whether the wireless communication device is located in the available area/range of the defined signal (e.g., LP-WUS signal) based on criteria provided by the wireless communication node. If the wireless communication device is located in the available area/range of the defined signal, the wireless communication device can enter the first low-power operating state (e.g., LP-WUS-ON sub-state) and/or monitor for the defined signal (e.g., LP-WUS signal).
   In certain embodiments, the wireless communication device may transition from the first low-power operating state to a legacy state, in response to receiving the defined signal that includes an indication that a network may have a message for the wireless communication device, and/or that the network may intend to wake up the wireless communication device. For example, when the wireless communication device is in the first low-power operating state (e.g., LP-WUS-ON sub-state), if the wireless communication device receives a defined signal (e.g., LP-WUS signal) with status of “ON”, the wireless communication device can enter, transition and/or move into a normal idle or inactive state (e.g., a legacy state), to monitor for legacy paging messages.
   In certain embodiments, the wireless communication device may transition from the first low-power operating state to the low-power off state (e.g., LP-WUS-OFF sub-state), if the defined signal is not detected after a first defined duration (e.g., P1). The wireless communication device may transition from the low-power off state to the first low-power operating state, after a second defined duration (e.g., P2). For example, when the wireless communication device is in the first low-power operating state (e.g., LP-WUS-ON sub-state), if the wireless communication device fails to receive a defined signal (e.g., LP-WUS signal) and/or a defined signal with a status of “ON” in a first defined duration, the wireless communication device can transition to the low-power off state (e.g., LP-WUS-OFF sub-state). After the wireless communication device remains in the low-power off state for second defined duration (e.g., a P2 time period), the wireless communication device can retransition back to the first low-power operating state. The first defined duration and/or second defined duration can be pre-defined and/or configured by the wireless communication node.
   In certain embodiments, the wireless communication device may transition from the first low-power operating state to the legacy state, if the defined signal, or the defined signal that includes an indication that a network may have a message for the wireless communication device (e.g., LP-WUS signal with status of “ON”), is not detected after a first defined duration (e.g., P3). For example, if the wireless communication device is in the first low-power operating state (e.g., LP-WUS-ON sub-state) and fails to receive a defined signal (e.g., LP-WUS signal) and/or a LP-WUS signal with status of “ON” in a first defined duration (e.g., P3), the wireless communication device can transition into a normal inactive state (or back into an idle state after a first defined duration, such as a P4 time period), to monitor a legacy defined signal (e.g., WUS) and/or a physical downlink control channel (PDCCH). Such a process can avoid the case that the wireless communication device has been stuck in the first low-power operating state (e.g., LP-WUS-ON sub-state) because it fails to receive a defined signal for an extended period of time. Such a process can correct and/or address the possible abnormality of the wireless communication device from time to time. Furthermore, said process may provide the wireless communication device with the opportunity to transition into a normal operating state (e.g., a legacy state), to perform measurement and/or synchronization operations.
   In certain embodiments, the wireless communication device may transition from the first low-power operating state to the legacy state, if the wireless communication device detects a cell change. For instance, if the wireless communication device is in the first low-power operating state (e.g., LP-WUS-ON sub-state) and detects a cell change, the wireless communication device may enter and/or transition to a legacy state (e.g., a legacy idle and/or inactive state), to monitor for a legacy defined signal (e.g., WUS) and/or a PDCCH.
   If the wireless communication device is in the first low-power operating state (e.g., LP-WUS-ON) and/or in the LP-WUS-OFF sub-state, and uplink service data is received from a higher layer of the wireless communication device, the wireless communication device can transition from the first low-power operating state and/or the LP-WUS-OFF sub-state into a legacy state (e.g., a normal state, such as an idle or inactive state).
In certain embodiments, the wireless communication device may transition between a first state (e.g., a first operating state) and a second state (e.g., a second operating state) according to (e.g., in response to, triggered by, upon meeting a condition comprising, after, based on a result of, etc.) an indication in the defined signal. For instance, the operating state transition between LP-WUS-ON (e.g., the first state) and LP-WUS-OFF (e.g., the low-power off state, the second state and/or other operating states) can be triggered by information carried in the defined signal (e.g., an indication in the defined signal). In one example, the operating state transition between LP-WUS-ON/LP-WUS-OFF (or a new state, such as LP-WUS_IDLE or LP-WUS_INACTIVE (e.g., a simple state) or a combination of LP-WUS-ON and LP-WUS-OFF sub-states) and one or more legacy states can be triggered by information carried in the defined signal (e.g., an indication in the defined signal).
   By default, reception of the defined (e.g., LP-WUS signal) can trigger the wireless communication device to move (e.g., transition) to a normal state (e.g., legacy state) and/or monitor a legacy PDCCH channel. Moreover, the information carried in the defined signal (e.g., an indication in the defined signal) can indicate to the wireless communication device to transition to a particular state (e.g., a second state, such as a normal idle state and/or a normal inactive state).
   The information carried in the defined signal (e.g., an indication in the defined signal) can indicate to the wireless communication device to transition from the first low-power operating state (e.g., LP-WUS-ON) to LP-WUS-OFF. The information carried in the defined signal can further indicate to the wireless communication device to remain in the LP-WUS-OFF sub-state for a certain time period (e.g., P5).
In certain embodiments, the wireless communication device may transition between a first state (e.g., a first operating state) and a second state (e.g., a second operating state) according to (e.g., in response to, triggered by, upon meeting a condition comprising, after, based on a result of, etc.) another defined signal and/or a specific type of defined signal. For instance, the operating state transition between LP-WUS-ON (e.g., the first state) and LP-WUS-OFF (e.g., the low-power off state, the second state and/or other operating states) can be triggered by another defined signal and/or a specific type of defined signal. In one example, the operating state transition between LP-WUS-ON/LP-WUS-OFF (or a new state, such as LP-WUS_IDLE or LP-WUS_INACTIVE (e.g., a simple state) or a combination of LP-WUS-ON and LP-WUS-OFF sub-states) and one or more legacy states can be triggered by another defined signal and/or a specific type of defined signal.
In certain embodiments, the wireless communication device may send a message to a wireless communication node to stop transmission of defined signals, prior to transitioning to a low-power off state. The wireless communication device may transition from the first low-power operating state to the low-power off state, after sending the message. For example, just before the wireless communication device transitions to the LP-WUS-OFF sub-state (e.g., low-power off state) or is back to a legacy state (e.g., a normal idle or inactive state), the wireless communication node should be indicated to stop the transmission of defined signals.
   Based on a consistent understanding of the duty cycle of the state transition, the wireless communication node can stop the transmission of defined signals at a time point T1. The time point T1 can be when the wireless communication device transitions to the LP-WUS-OFF sub-state or is back to a normal idle or inactive state. The wireless communication node can determine and/or calculate the time point T1 based on (or according to) pre-defined parameters related to the duty cycle and/or the statistics of the trigger events.

### B. Embodiment 2: Design of the Defined Signal

In some embodiments, the defined signal can be supported by the wireless communication device and/or the wireless communication node. The defined signal can be a power-saving signal to be monitored before the wireless communication device monitors a PDCCH channel for getting paging in an idle state. Without detecting the defined signal, the wireless communication device may be unable to monitor the PDCCH. In some embodiments, the power consumption associated with receiving the defined signal(s) is much lower than (e.g., about one-sixteenth) the power consumption associated with monitoring the PDCCH. Therefore, detecting the defined signal can enhance and/or improve the power saving capabilities of the wireless communication device, especially in applications with sparse paging targeted to the wireless communication device. In certain embodiments, for a wireless communication device configured with a long eDRX cycle, a defined signal can be mapped to multiple paging occasions (POs), causing further power-saving benefits for the wireless communication device.

In certain embodiments, a novel defined signal (e.g., LP-WUS signal) can be considered for applications that have power saving and/or low latency requirements. As mentioned above, for power saving purposes, the wireless communication device in a LP-WUS-ON sub-state (e.g., first low-power operating state) can detect (e.g., continuously and/or intermittently) a defined signal without performing further actions. For example, the wireless communication device may stop and/or cancel legacy measurements on neighbor cells and/or a serving cell. As such, the wireless communication device may lack information for cell re-selection. Moreover, without continuously monitoring for system information block (SIB) messages, the wireless communication device may lose downlink synchronization.

In legacy paging monitoring mechanisms, the wireless communication device can monitor certain paging resources determined by a paging occasion (PO), a paging frame (PF), a paging narrowband (PNB), a WUS/GWUS location and/or other information, to receive a WUS/GWUS signal for a paging message. The identification of the wireless communication device and the number of related resources are involved in the calculation of paging resources. As such, the wireless communication devices can be grouped and/or distributed on different/distinct/separate paging resources, especially on time domain resources.

After introducing the defined signal (e.g., under the assumption that capable wireless communication devices are generally required to monitor the same defined signal), the previous natural distinction in time domain between the wireless communication devices can be lost. Moreover, when there is a paging targeted to a certain wireless communication device, the defined signal with “ON” can be sent by the wireless communication node, such that the defined signal may falsely wake-up other wireless communication devices without targeted paging.

In order to avoid potential conflicts and/or false wake-ups when capable wireless communication devices continuously monitor a same defined signal (e.g., LP-WUS signal), the following schemes can be considered:
In some embodiments, the defined signal can be specifically configured for the wireless communication device, and/or for a device group that includes the wireless communication device. In one example, introducing and/or configuring different/separate/distinct defined signals (e.g., LP-WUS signals/sequences) for different wireless communication devices and/or different device groups may include or correspond to a type of code division scheme.
In certain embodiments, the defined signal may be scheduled on at least one resource specifically configured for the wireless communication device, and/or for the device group. In one example, different resources (e.g., different frequency domain resources) can be configured for different wireless communication devices and/or different device groups (e.g., for monitoring defined signals). A specific configuration of a defined signal (e.g., a device-specific LP-WUS configuration) can include, specify and/or indicate said resources.

In some embodiments, the defined signal can be used for detecting cells (e.g., surrounding cells) and/or for determining the quality (e.g., channel quality) of the cells.
In certain embodiments, the wireless communication device may detect at least one defined signal (e.g., from a group of background defined signals) each corresponding to a respective cell and indicative of at least one of: an existence of the respective cell and/or a channel quality of the respective cell. In one example, the wireless communication device may detect a group of defined signals (e.g., background defined signals). The defined signals may lack an identification for a certain wireless communication device (e.g., not specific to a particular wireless communication device and/or device group). The defined signals may differ from each other by an offset and/or a shifting factor. In some embodiments, the existence and/or quality of a defined signal may correspond to the existence and/or channel quality of a certain cell. The mapping between said group of defined signals and the corresponding cells can be configured by the wireless communication node. The defined signals can be sent and/or transmitted continuously, and/or according to a pre-defined periodicity. Once the wireless communication device acquires/obtains information of the existence and/or the channel quality of the cell(s), the wireless communication device can return to (e.g., transition to) a normal state (a legacy state, such as an idle state and/or an inactive state), to perform measurement and/or synchronization operations.
In certain embodiments, the wireless communication device may detect at least one defined signal (e.g., from a group of background defined signals) each corresponding to a respective cell. The wireless communication device may perform clock synchronization using (or according to) the at least one defined signal. For example, the defined signal(s) and/or a device-specific defined signal can be used for clock synchronization with a wireless communication node. However, based on a small duty cycle (such as 2%), the defined signal can be sent/transmitted in a small window with a large interval, and therefore clock synchronization can be problematic. As such, defined signals can be used for clock synchronization if the wireless communication device performs continuous monitoring for the defined signal(s).

In certain embodiments, a cell-specific defined signal can be used according to one or more of the following:
In some embodiments, the defined signal may include an indication to activate or deactivate the monitoring of subsequent defined signals. For example, cell-specific defined signal(s) can be used to activate and/or deactivate the monitoring for device-specific defined signals.
In some embodiments, the defined signal may include an indication to indicate arrival of a paging message to one or more wireless communication devices that moved from another cell to the respective cell. For example, cell-specific LP-WUS signal(s) can be used to indicate the arrival of the paging message to wireless communication devices moving to a second cell from a first cell.

### C. Embodiment 3: Compensation of Coverage

In certain embodiments, envelope detection may cause degradation of sensitivity (e.g., down to 60 dB-80 dB). As such, due to the nature of the defined signal, the defined signal can be used in adequate coverage conditions.
In certain embodiments, a configuration of a defined signal can include a factor. The factor may include or correspond to an allowed area/range of coverage and/or detecting sensitivity, corresponding to a type of defined signal design and/or a transmission approach. Based on the factor, wireless communication device can determine whether the wireless communication device is within a signal coverage region for receiving the defined signal. Furthermore, the wireless communication device can determine whether to start monitoring for the defined signal. Unlike other embodiments (e.g., see Embodiment 1), Embodiment 3 describes an approach based on a wireless communication device (e.g., UE-based scheme). For instance, the wireless communication device may enter or maintain the first low-power operating state in response to being within the signal coverage region. In one example, if the wireless communication device determines that the wireless communication device is outside a signal coverage region (e.g., coverage fails to meet certain conditions), the wireless communication device can determine to stop monitoring for the defined signal, and or remain in a first low-power operating state (e.g., a normal state).
In certain embodiments, a configuration of a defined signal can include a time domain extension/indication for increasing a transmission energy for the defined signal. For example, said configuration can include a Tx energy/intensity domain reinforcement for the transmission of a defined signal, to extend the allowed area/range of coverage and/or sensitivity of detection. As such, and in some embodiments, the wireless communication device may send and/or transmit a request for extending time domain resources for the defined signal and/or increasing a transmission energy for the defined signal.

### D. Embodiment 4: Reduction of Delay

In some embodiments, the wireless communication device can remain in a state with very low power consumption (e.g., a deep sleep status), in which the wireless communication device may detect the defined signal. As such, the wireless communication device may use a time duration (e.g., a “warm-up” time) for transitioning to (e.g., returning to) a normal state (e.g., a RRC idle state and/or a RRC inactive state), to detect a PDCCH responsive to receiving a defined signal. Considering that different wireless communication devices may have different capabilities for supporting the defined signal, the wireless communication devices can use different/distinct time durations (e.g., a “warm-up” times) before detecting a PDCCH. In certain embodiments, a non-zero interval (e.g., a time offset) parameter/indication can be used to define the time duration(s) between an end of a defined signal transmission and a start of a next PO. Moreover, the parameter/indication may be defined/configured according to different DRX configurations. For example, if the wireless communication device is configured with a long DRX cycle, the wireless communication device may use a long/large time duration (e.g., time-offset parameter/indication). A longer/larger time duration can allow and/or provide for enough time to demodulate the defined signal, and/or to “warm-up” from a low power consumption status/state (e.g., to transition from the first low-power operating state or a state incorporating the first low-power operation state, to a RRC idle state and/or a RRC inactive state).

In one example, a wireless communication device in a first low-power operating state (e.g., LP-WUS-ON sub-state) can remain in a deep sleep status/status. As such, the wireless communication device can use a longer “warm-up” time duration (e.g., a time duration for the wireless communication device to transition from the first low-power operation state or a state incorporating the first low-power operation state) to transition (or return) to a normal state (e.g., a RRC idle state and/or a RRC inactive state).

In certain embodiments, the wireless communication device can send, transmit, report, provide, and/or communicate (e.g., to a wireless communication node) an indication of a time duration for the wireless communication device to transition from the first low-power operation state (e.g., LP-WUS-ON sub-state) and/or a state incorporating the first low-power operation state (e.g., LP-WUS_IDLE and/or LP-WUS_INACTIVE), to a RRC idle state (e.g., normal idle state) or a RRC inactive state (e.g., inactive state). The time duration can be included in a report of the capability of the wireless communication device (e.g., UE capability report) and/or a report of a preference of the wireless communication device (e.g., UE preference report).

### E. Embodiment 5: Negotiation and Capability of the Wireless Communication Device

In some embodiments, one or more wireless communication devices in different applications may have distinct and/or separate power saving requirements, and/or different service patterns. As such, the wireless communication device(s) can select, determine and/or choose one or more alternative approaches for using the defined signal (e.g., LP-WUS signal).

In certain embodiments, the wireless communication node can configure, determine and/or provide a configuration for the defined signal (e.g., LP-WUS related configuration) based on the capability of the wireless communication device to support the defined signal. The configuration for the defined signal can include at least one of the following:
The configuration can include at least one manner for transitioning between states. For example, the configuration can include a pattern for transitioning between states (e.g., staying in a first state and/or transition between several states or sub-states).
The configuration can include a manner for monitoring the defined signal (e.g., continuous manner, discontinuous manner, periodic manner, aperiodic manner with a periodicity, and/or other manners).
The configuration can include a criteria (e.g., a threshold) for determining a signal coverage region and/or range for the defined signal. In certain embodiments, the wireless communication device may determine the signal coverage region and/or range according to (e.g., by meeting or exceeding) one or more thresholds (e.g., a first threshold, a second threshold, a third threshold, a fourth threshold, a fifth threshold and/or a sixth threshold) and/or other criteria. In certain embodiments, a first threshold can be associated with a quality of a signal (e.g., Reference Signal Received Power (RSRP), Reference Signal Received Quality (RSRQ), and/or Received Signal Strength Indication (RSSI)). A second threshold can be associated with a signal energy. In certain embodiments, the wireless communication device may determine the signal coverage region and/or range if the signal quality exceeds a third/fourth/fifth/sixth threshold(s) (e.g., how much the signal energy exceeds the third/fourth/fifth/sixth threshold(s). In some embodiments, the wireless communication device may determine the signal coverage region and/or range according to (or based on) statistical properties of one or more events (e.g., how many times the wireless communication device transitions from a first low-power operating state (e.g., LP-WUS-ON) to a second low-power operating state (e.g., LP-WUS-OFF sub-state)).
The configuration can include a criteria and/or threshold for determining infeasibility of performing monitoring for the defined signal, and/or for triggering a transition to a RRC idle state and/or a RRC inactive state. In one example, the threshold for determining infeasibility of performing monitoring for the defined signal can be used for a transition to a RRC idle state and/or a RRC inactive state. For instance, the wireless communication device may determine an infeasibility of performing monitoring for the defined signal it the wireless communication device meets or exceeds (or is below) a corresponding threshold.
The configuration can include a design and/or format of the defined signal (e.g., the LP-WUS signal(s) design). In addition to the physical layer design, the design and/or format of the defined signal may include a method for multiplexing the defined signal(s) with one or more existing signals. In some embodiments, the design and/or format of the defined signal may include one or more steps for time-domain extension and/or energy domain reinforcement for the transmission of the defined signal.
The configuration can include a design or format for at least one defined signal each corresponding to a respective cell (e.g., the mapping/association between the defined signal(s) and the surrounding cells).

In certain embodiments, the wireless communication device can receive the configuration via at least one of: dedicated signaling, broadcast signaling, a user plane packet, and/or downlink signaling during at least one of: RRC establishment procedure, RRC resume procedure, RRC reconfiguration procedure, RRC reestablishment procedure, RRC release procedure, early data transmission procedure, and/or small data transmission procedure. For example, the wireless communication device can receive the configuration via one or more messages (e.g., RRC messages).
During a RRC connection procedure (e.g., a recent RRC connection procedure), the wireless communication device can receive the configuration via RRCConnectionRelease, RRCEarlyDataComplete, RRCConnectionReject, RRCConnectionReconfiguration, RRCConnectionReestablishment, RRCConnectionResume, RRCConnectionSetup, and/or other messages/signaling.
During a data transmission procedure (e.g., a recent data transmission procedure), the wireless communication device can receive the configuration via a user plane packet.

In some embodiments, the wireless communication device may send/transmit a request (e.g., using a device-specific or device group-specific request) for the configuration for the defined signal. A device-specific and/or device group-specific request, for example, can include at least one of the following:
The request can include at least one manner for transitioning between states. For example, the configuration can include a pattern for transitioning between states.
The request can include a supported and/or preferred number of defined signals.
The request can include a preferred signal energy of the defined signal(s).

In certain embodiments, the wireless communication device can receive the request via at least one of: dedicated signaling, broadcast signaling, a user plane packet, and/or downlink signaling during at least one of: RRC establishment procedure, RRC resume procedure, RRC reconfiguration procedure, RRC reestablishment procedure, RRC release procedure, early data transmission procedure, and/or small data transmission procedure. For example, the wireless communication device can receive the configuration via one or more messages (e.g., RRC messages).
During a RRC connection procedure (e.g., a recent RRC connection procedure), the wireless communication device can receive the request via RRCConnectionRequest, RRCConnectionResumeRequest, RRCConnectionReestablishmentRequest, RRCEarlyDataRequest, UEInformationRequest, PURConfigurationRequest, RRCConnectionReconfigurationComplete, RRCConnectionReestablishmentComplete, RRCConnectionResumeComplete, RRCConnectionSetupComplete, and/or other messages.
During a data transmission procedure (e.g., a recent data transmission procedure), the wireless communication device can receive the request via a user plane packet.

### F. Embodiment 6: Impact on a Wireless Communication Node

In some embodiments, the configuration for the defined signal may be suitable and/or applicable in the cell where the configuration is provided. As such, one or more approaches can be used to avoid improper use of the defined signal.

In certain embodiments, a first cell (e.g., a cell where the configuration is provided) may deliver, send and/or provide the configuration for the defined signal (e.g., part of the configuration for the defined signal) and/or an identification (e.g., an identifier) of a first cell to the wireless communication node. The wireless communication node can further transfer the configuration for the defined signal and/or the identification of the first cell to the target cell(s), along with a paging message. If the target cell determines itself is the first cell, the target cell can change the defined signal (e.g., monitored by the wireless communication device if the wireless communication device is in this target cell) to “ON”. Otherwise, the wireless communication device and/or the target cell can use and/or perform one or more of the following:
In some embodiments, the wireless communication device may use the configuration for the defined signal if the configuration is for the cell in which the wireless communication device currently resides (e.g., in a cell where the configuration is provided). If the wireless communication device moves and/or enters into another cell, the wireless communication device may terminate/stop the monitoring of the defined signal if the configuration is not for the cell in which the wireless communication device currently resides. In some embodiments, the target cell may transfer and/or send a legacy paging message to the wireless communication device.
In some embodiments, the wireless communication device can monitor the defined signal if the configuration is for the cell in which the wireless communication device currently resides. For example, the wireless communication device can monitor a cell-specific defined signal if the wireless communication device moves from another cell to the current target cell. The target cell can transmit, send and/or broadcast a cell-specific defined signal with status of “ON” (e.g., as discussed in Embodiment 2). Upon reception of the cell-specific defined signal, the wireless communication device may transition to (or enter) to a normal operating state.

### G. Operating in a Low-Power State

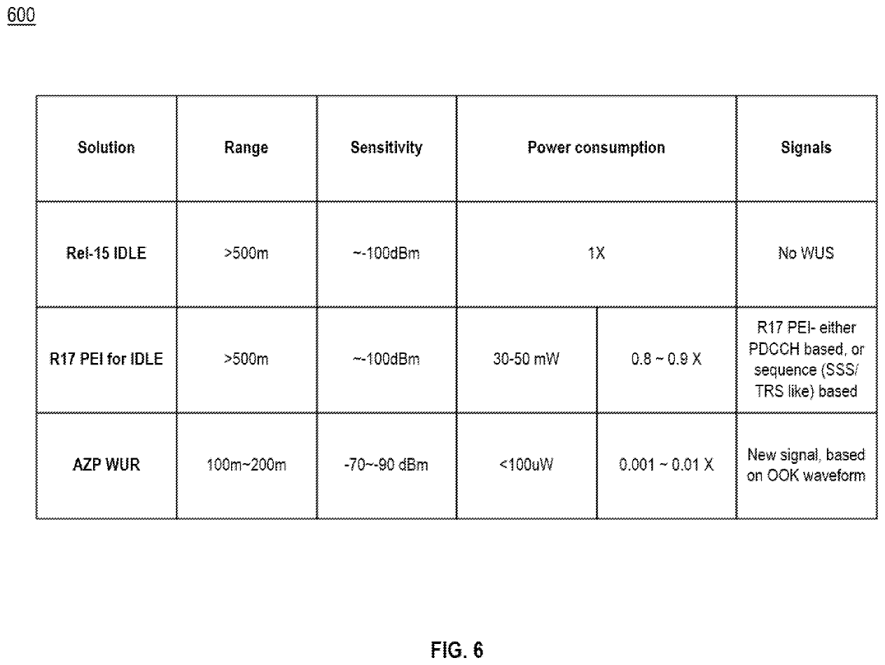

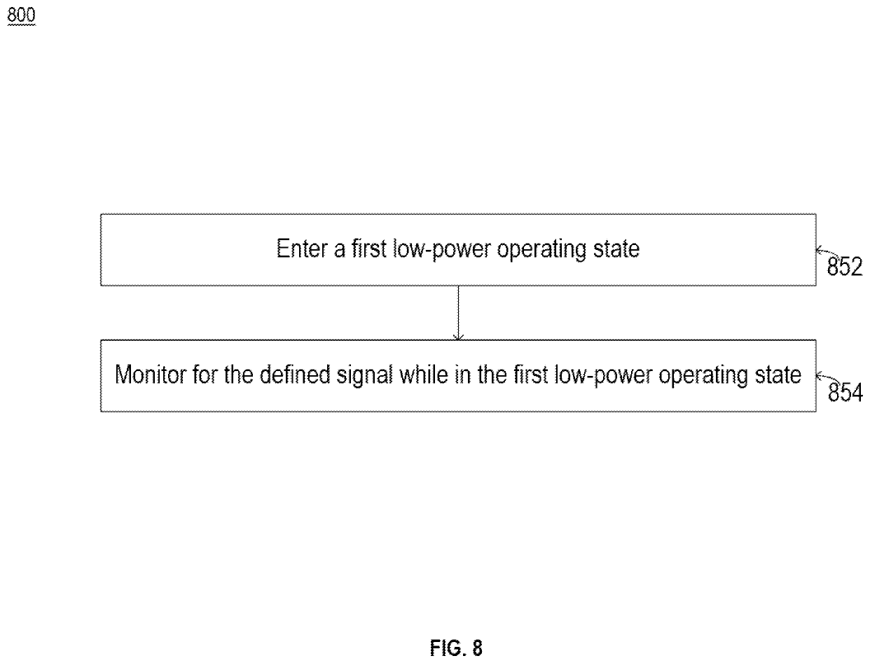

FIG. 8 illustrates a flow diagram of a method 800 for operating in a low-power state (e.g., a first low-power operating state). The method 800 may be implemented using any of the components and devices detailed herein in conjunction with FIGS. 1-7. In overview, the method 800 may include entering a first low-power operating state to monitor for a defined signal (852). The method 800 may include monitoring for the defined signal, while in the first low-power operating state (854).

Referring now to operation (852), and in some embodiments, a wireless communication device (e.g., a UE) may enter and/or move into a first low-power operating state (e.g., LP-WUS-ON state, a legacy state, and/or other operating states) to monitor for a defined signal. The defined signal can include or correspond to a specific and/or predefined signal sent by a wireless communication node. In one example, the defined signal may be configured and/or used to wake-up the wireless communication device from the first low-power operating state (e.g., a new ultra-low-power state). In some embodiments, entering the first low power operating state may comprise transitioning and/or changing between a low-power off state (e.g., LP-WUS-OFF sub-state) and the first low-power operating state. Said transitioning and/or changing can be performed according to (or based on) a defined (e.g., pre-defined and/or default) configuration, a configuration from a wireless communication node (e.g., a base station), and/or other configurations. In certain embodiments, the transitioning can be according to at least one of: a defined duty cycle between the low-power off state and the first low-power state, a transition between the low-power off state and the first low-power state after a defined time period or according to a defined periodicity, and/or a transition between the low-power off state and the first low-power state according to a defined length of time period when no signal is detected. In certain embodiments, the transitioning can be according to at least one of: a transition between the low-power off state and the first low-power state according to a defined number of detections in which no signal is detected, and/or a transition between the low-power off state and the first low-power state if energy detected from the defined signal meets a condition (e.g., exceeds a condition, is below a condition, matches the condition, and/or satisfies the condition) with respect to a pre-defined or configured first threshold. In certain embodiments, the transitioning can be according to a transition between the low-power off state and the first low-power state if an amount of change in energy detected from the defined signal meets a condition (e.g., exceeds a condition, is below a condition, matches the condition, and/or satisfies the condition) with respect to a pre-defined or configured second threshold.

In some embodiments, the wireless communication device may transition between a first state and a second state. For example, the wireless communication device may transition between the first state and the second state according to (e.g., in response to, triggered by, upon meeting a condition comprising, after, and/or based on a result of) at least one of: an event, an indication in the defined signal, another defined signal, a specific type of defined signal, a defined length of time period when no signal is detected, and/or a defined number of detections in which no signal is detected. In one example, the wireless communication device may transition between the first state and the second state according to (e.g., in response to, triggered by, upon meeting a condition comprising, after, and/or based on a result of) at least one of: energy detected from the defined signal, an amount of change in energy detected from the defined signal, energy detected from the defined signal exceeds a pre-defined or configured first threshold, and/or a result of comparing (e.g., exceeding, matching, meeting, satisfying and/or being below a threshold) an amount of change in the energy detected from the defined signal with a pre-defined or configured second threshold. In one example, the wireless communication device may transition between the first state and the second state according to (e.g., in response to, triggered by, upon meeting a condition comprising, after, and/or based on a result of) at least one of: a channel quality measured after a condition between energy detected from the defined signal and the pre-defined or configured first threshold is fulfilled (e.g., exceeding a condition, matching a condition, meeting a condition, satisfying condition and/or being below a condition), and/or a channel quality measured after a condition between an amount of change in energy detected from the defined signal and the pre-defined or configured second threshold is fulfilled.

In one example, the wireless communication device may transition between the first state and the second state according to (or based on) a channel quality measured after a condition between energy detected from the defined signal and the pre-defined or configured first threshold is fulfilled, meets another condition with respect to a pre-defined or configured third threshold (e.g., exceeding the another condition, matching the another condition, meeting the another condition, satisfying the another condition and/or being below the another condition). In one example, the wireless communication device may transition between the first state and the second state according to a change of channel quality measured after a condition between an amount of change in energy detected from the defined signal and the pre-defined or configured second threshold is fulfilled, meets another condition with respect to a pre-defined or configured fourth threshold. In certain embodiments, the first state and the second state may each comprise: the first low-power operating state, a low-power off state (e.g., LP-WUS-OFF sub-state), a combination state that incorporates at least one period of being in the first low-power state (e.g., combination state that combines LP-WUS-ON and LP-WUS-OFF sub-states), and/or a legacy state. The legacy state may comprise a radio resource control (RRC) idle state, a RRC inactive state, or a RRC connected state.

In certain embodiments, the wireless communication device may transition from the first low-power operating state to the legacy state. In one example, the wireless communication device may transition from the first low-power operating state to the legacy state in response to receiving and/or obtaining the defined signal. The defined signal can include and/or provide an indication (e.g., LP-WUS signal with status of “ON”) that a network (e.g., wireless communication node) may have a message for the wireless communication device. In one example, the defined signal can include and/or provide an indication that the network may intend to wake up the wireless communication device. In some embodiments, the wireless communication device may transition from the first low-power operating state to the low-power off state (e.g., LP-WUS-OFF sub-state), if the defined signal is not detected after a first defined duration (e.g., duration P1). In certain embodiments, the wireless communication device may transition from the low-power off state to the first low-power operating state, after a second defined duration (e.g., duration P2). In some embodiments, the wireless communication device may transition from the first low-power operating state to the legacy state if the defined signal (e.g., or the defined signal that includes an indication that a network may have a message for the wireless communication device) is not detected after a first defined duration (e.g., duration P3 and/or P4). In one example, the wireless communication device may transition from the first low-power operating state to the legacy state if the wireless communication device detects a cell change. In certain embodiments, the wireless communication device may transition from the first low-power operating state to the second state in response to the defined signal indicating to transition specifically to the second state. Responsive to transitioning to the second state, the wireless communication device may remain in the second state for a pre-defined/pre-determined time period/duration.

Referring now to operation (654), and in some embodiments, the wireless communication device may monitor for (and/or detect) the defined signal. For instance, the wireless communication device can monitor for the defined signal while in the first low-power operating state. In certain embodiments, the wireless communication node may send, transmit, broadcast, and/or communicate the defined signal being monitored by the wireless communication device. In some embodiments, monitoring for the defined signal may comprise monitoring for the defined signal continuously and/or intermittently over a length of time. In certain embodiments, the defined signal can include or correspond to a wake-up signal (WUS) and/or a signal for triggering state transition. In some embodiments, the wireless communication device can monitor for the defined signal, while the wireless communication device is in the first low-power operating state or in a second low-power operating state. The second low-power operating state may comprise: a radio resource control (RRC) idle state, a RRC inactive state, a RRC connected state, a state that incorporates at least one period of being in the first low-power state, and/or other states.

In some embodiments, the wireless communication device may send, transmit, communicate and/or broadcast a message to a wireless communication node. The wireless communication device may send the message to stop transmission of defined signals, prior to transitioning to a low-power off state. In certain embodiments, the wireless communication device may transition from the first low-power operating state to the low-power off state, after sending the message. In some embodiments, the defined signal can be specifically configured for the wireless communication device and/or for a device group. The device group may include the wireless communication device. In certain embodiments, the defined signal may be scheduled on at least one resource. The at least one resource can be specifically configured for the wireless communication device, and/or for the device group. In some embodiments, the wireless communication device may detect and/or identify at least one defined signal. Each defined signal may correspond to (or be associated with) a respective cell. In one example, each defined signal can be indicative of (e.g., may indicate) at least one of: an existence of the respective cell and/or a channel quality of the respective cell. In some embodiments, the wireless communication device may detect at least one defined signal. Each defined signal may correspond to (or be associated with) a respective cell. In one example, the wireless communication device may perform clock synchronization by using (or based on) the at least one defined signal. In some embodiments, the defined signal may include an indication to activate or deactivate the monitoring of subsequent defined signals. In certain embodiments, the defined signal may include an indication to indicate arrival of a paging message to one or more devices. The one or more device may have moved from another cell to the respective cell.

In certain embodiments, the wireless communication device may determine and/or identify whether the wireless communication device is within a signal coverage region for receiving the defined signal. In some embodiments, the wireless communication device may enter and/or maintain the first low-power operating state in response to being within the signal coverage region. In some embodiments, the wireless communication device may send, transmit and/or broadcast (e.g., to one or more wireless communication nodes) a request for extending time domain resources for the defined signal and/or increasing a transmission energy for the defined signal. The wireless communication device may send and/or transmit said request without detecting a defined signal. In one example, the wireless communication device may send, transmit and/or broadcast an indication of a time duration for the wireless communication device to transition from the first low-power operation state (or a state incorporating the first low-power operation state) to a radio resource control (RRC) idle state and/or a RRC inactive state. In some embodiments, the wireless communication device may send and/or provide a capability of the wireless communication device to support the defined signal. In certain embodiments, the wireless communication device may receive and/or obtain (e.g., from one or more wireless communication nodes) at least one of: a configuration for the defined signal, an indication for triggering a transition between states, and/or an indication for indicating to the wireless communication device to enter the first low-power operating state. In some embodiments, the wireless communication node may provide and/or specify (e.g., to the wireless communication device) a configuration for transmitting a defined signal or an indication. The wireless communication node can send, transmit and/or communicate the defined signal.

In some embodiments, the configuration or the indication can be received (e.g., by the wireless communication device) via at least one of: a dedicated signaling, a broadcast signaling, a user plane packet, and/or a downlink signaling. The downlink signaling can be transmitted during a RRC establishment procedure, RRC resume procedure, RRC reconfiguration procedure, RRC reestablishment procedure, RRC release procedure, early data transmission procedure, and/or small data transmission procedure. In certain embodiments, the configuration can include at least one manner for transitioning between states. In one example, the configuration can include a manner for monitoring the defined signal and/or a criteria for determining a signal coverage region or range for the defined signal. In one example, the configuration can include a criteria or threshold for determining infeasibility of performing monitoring for the defined signal, or for triggering a transition to a RRC idle state or a RRC inactive state. In certain embodiments, the configuration may comprise a design or format of the defined signal, and/or a design or format for at least one defined signal. Each defined signal may correspond to (or be associated with) a respective cell. In some embodiments, the wireless communication device may determine whether the configuration is for a cell in which the wireless communication device currently resides. In certain embodiments, the wireless communication device may use the configuration if the configuration is for the cell in which the wireless communication device currently resides. The wireless communication device may terminate the monitoring of the defined signal if the configuration is not for the cell in which the wireless communication device currently resides. The wireless communication device may monitor the defined signal if the configuration is for the cell in which the wireless communication device currently resides.

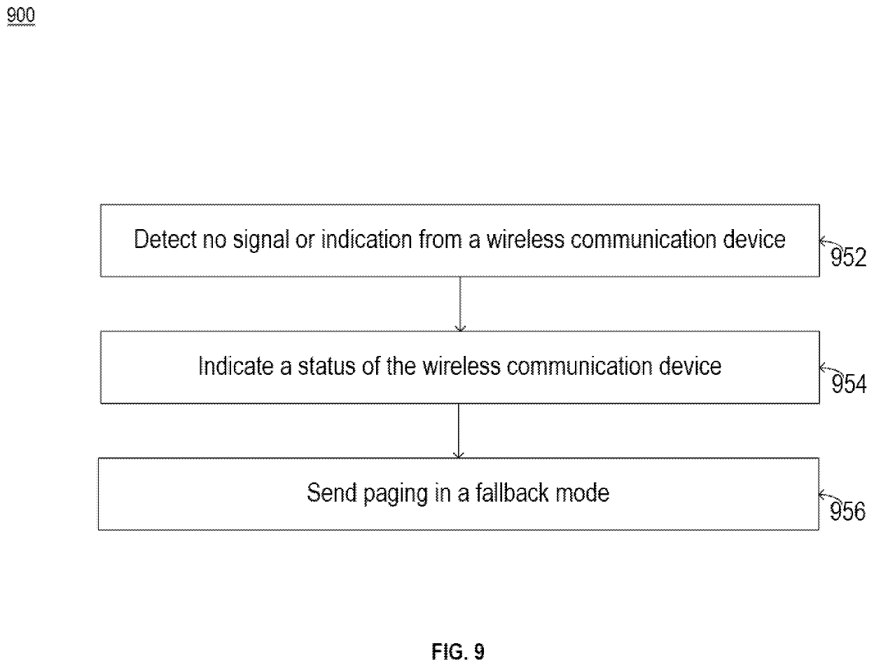

FIG. 9 illustrates a flow diagram of a method 900 for operating in a low-power state (e.g., a first low-power operating state). The method 900 may be implemented using any of the components and devices detailed herein in conjunction with FIGS. 1-7. In overview, the method 900 may include detecting no signal or indication from a wireless communication device (952). The method 900 may include indicating a status of the wireless communication device (954). The method 900 may include sending paging in a fallback mode (956)

Referring now to operation (952), and in some embodiments, a wireless communication node (e.g., a gNB) may detect no signal or indication (e.g., may fail to detect a signal or indication) from a wireless communication device (e.g., can refer to “the wireless communication device” mentioned in connection with the described embodiments). In one example, the wireless communication node may detect no signal or indication (e.g., may fail to detect a signal or indication) from any wireless communication device. The wireless communication node may indicate a status of the wireless communication device to a core network (954). The wireless communication node may send, transmit and/or communicate paging (e.g., a paging messages) in a fallback mode to the wireless communication device (956). The fallback mode may comprise sending the paging in a defined way (e.g., a legacy way), sending the paging using defined resources, sending the paging based on a configuration or indication from the core network, and/or sending the paging in all cells in a registration area of the wireless communication device.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A method comprising:
entering, by a wireless communication device, a first low-power operating state to monitor for a defined signal; and
monitoring, by the wireless communication device, for the defined signal, while in the first low-power operating state.

2. The method of claim 1,
wherein monitoring for the defined signal comprises monitoring for the defined signal continuously or intermittently over a length of time,
wherein the defined signal includes a wake-up signal (WUS) or a signal for triggering state transition.

3. The method of claim 1, comprising:
monitoring, by the wireless communication device, for the defined signal, while the wireless communication device is in the first low-power operating state or in a second low-power operating state,
wherein the second low-power operating state comprises: a radio resource control (RRC) idle state, a RRC inactive state, a RRC connected state, or a state that incorporates at least one period of being in the first low-power state.

4. The method of claim 1, wherein entering the first low-power operating state comprises:
transitioning between a low-power off state and the first low-power operating state, according to a defined configuration, or a configuration from a wireless communication node, wherein the transitioning is according to at least one of:
a defined duty cycle between the low-power off state and the first low-power state,
a transition between the low-power off state and the first low-power state after a defined time period or according to a defined periodicity,
a transition between the low-power off state and the first low-power state according to a defined length of time period when no signal is detected,
a transition between the low-power off state and the first low-power state according to a defined number of detections in which no signal is detected,
a transition between the low-power off state and the first low-power state if energy detected from the defined signal meets a condition with respect to a pre-defined or configured first threshold, or
a transition between the low-power off state and the first low-power state if an amount of change in energy detected from the defined signal meets a condition with respect to a pre-defined or configured second threshold.

5. The method of claim 1, comprising:
transitioning, by the wireless communication device, between a first state and a second state, according to at least one of:
an event,
an indication in the defined signal,
another defined signal,
a specific type of defined signal,
a defined length of time period when no signal is detected,
a defined number of detections in which no signal is detected,
energy detected from the defined signal, an amount of change in energy detected from the defined signal,
energy detected from the defined signal exceeds a pre-defined or configured first threshold, a result of comparing an amount of change in the energy detected from the defined signal with a pre-defined or configured second threshold,
channel quality measured after a condition between energy detected from the defined signal and the pre-defined or configured first threshold is fulfilled,
channel quality measured after a condition between an amount of change in energy detected from the defined signal and the pre-defined or configured second threshold is fulfilled,
channel quality measured after a condition between energy detected from the defined signal and the pre-defined or configured first threshold is fulfilled, meets another condition with respect to a pre-defined or configured third threshold, or
change of channel quality measured after a condition between an amount of change in energy detected from the defined signal and the pre-defined or configured second threshold is fulfilled, meets another condition with respect to a pre-defined or configured fourth threshold,
wherein the first state and the second state each comprises:
the first low-power operating state,
a low-power off state,
a combination state that incorporates at least one period of being in the first low-power state, or
a legacy state comprising a radio resource control (RRC) idle state, a RRC inactive state, or a RRC connected state.

6. The method of claim 5, comprising:
transitioning, by the wireless communication device, from the first low-power operating state to the legacy state, in response to receiving the defined signal that includes an indication that a network may have a message for the wireless communication device, or that the network may intend to wake up the wireless communication device.

7. The method of claim 5, comprising:
transitioning, by the wireless communication device, from the first low-power operating state to the low-power off state, if the defined signal is not detected after a first defined duration;
transitioning, by the wireless communication device, from the low-power off state to the first low-power operating state, after a second defined duration.

8. The method of claim 5, comprising:
transitioning, by the wireless communication device, from the first low-power operating state to the legacy state, if:
the defined signal, or the defined signal that includes an indication that a network may have a message for the wireless communication device, is not detected after a first defined duration, or
the wireless communication device detects a cell change.

9. The method of claim 5, comprising:
transitioning, by the wireless communication device, from the first low-power operating state to the second state, in response to the defined signal indicating to transition specifically to the second state.

10. The method of claim 1, comprising:
sending, by the wireless communication device, a message to a wireless communication node to stop transmission of defined signals, prior to transitioning to a low-power off state; and
transitioning, by the wireless communication device, from the first low-power operating state to the low-power off state, after sending the message.

11. The method of claim 1, wherein the defined signal is:
specifically configured for the wireless communication device or for a device group that includes the wireless communication device; or
scheduled on at least one resource specifically configured for the wireless communication device, or for the device group.

12. The method of claim 1, comprising:
detecting, by the wireless communication device, at least one defined signal each corresponding to a respective cell and indicative of at least one of: an existence of the respective cell or a channel quality of the respective cell.

13. The method of claim 1, comprising:
detecting, by the wireless communication device, at least one defined signal each corresponding to a respective cell; and
performing, by the wireless communication device, clock synchronization using the at least one defined signal.

14. The method of claim 12, wherein the defined signal includes an indication to:
activate or deactivate the monitoring of subsequent defined signals; or
indicate arrival of a paging message to one or more devices that moved from another cell to the respective cell.

15. The method of claim 1, comprising:
determining, by the wireless communication device, whether the wireless communication device is within a signal coverage region for receiving the defined signal; and
entering or maintaining, by the wireless communication device, the first low-power operating state in response to being within the signal coverage region.

16. The method of claim 1, comprising:
sending, by the wireless communication device, at least one of:
a request for extending time domain resources for the defined signal or increasing a transmission energy for the defined signal,
an indication of a time duration for the wireless communication device to transition from the first low-power operation state or a state incorporating the first low-power operation state, to a radio resource control (RRC) idle state or a RRC inactive state, or
a capability of the wireless communication device to support the defined signal.

17. The method of claim 1, comprising:
receiving, by the wireless communication device, at least one of:
a configuration for the defined signal,
an indication for triggering a transition between states, or
an indication for indicating to the wireless communication device to enter the first low-power operating state.

18. The method of claim 1, wherein the configuration or the indication is received via at least one of:
a dedicated signaling,
a broadcast signaling, or
a user plane packet, or
a downlink signaling during at least one of: radio resource control (RRC) establishment procedure, RRC resume procedure, RRC reconfiguration procedure, RRC reestablishment procedure, RRC release procedure, early data transmission procedure, or small data transmission procedure.

19. The method of claim 17, wherein the configuration includes at least one of:
at least one manner for transitioning between states;
a manner for monitoring the defined signal;
a criteria for determining a signal coverage region or range for the defined signal;
a criteria or threshold for determining infeasibility of performing monitoring for the defined signal, or for triggering a transition to a radio resource control (RRC) idle state or a RRC inactive state;
a design or format of the defined signal; or
a design or format for at least one defined signal each corresponding to a respective cell.

20. A wireless communication device, comprising:
at least one processor configured to:
enter a first low-power operating state to monitor for a defined signal; and
monitor for the defined signal, while in the first low-power operating state.
